(19) United States
(12) Patent Application Publication
(10) Pub. No.: US 2014/0260916 A1
(43) Pub. Date: Sep. 18, 2014

(54) ELECTRONIC PERCUSSION DEVICE FOR DETERMINING SEPARATE RIGHT AND LEFT HAND ACTIONS

(71) Applicant: Samuel James Oppel, Norwalk, IA (US)

(72) Inventor: Samuel James Oppel, Norwalk, IA (US)

(21) Appl. No.: 14/166,611

(22) Filed: Jan. 28, 2014

Related U.S. Application Data
(60) Provisional application No. 61/802,594, filed on Mar. 16, 2013.

(51) Int. Cl. G10H 3/14

(52) U.S. Cl. CPC G10H 3/146
USPC 84/626

(57) ABSTRACT

A percussion electronic device allows a percussionist to learn, through electronic feedback, the correct playing of the right or left hand. The percussion device could be struck by the percussion player on the right or left side of the pad. Alternatively, the percussion device can connect to a visual detector to detect motions of the user's left and right hands. Computer software may display written music or instructions of what hand to play at what time and the percussion device would input the performance of the percussionist into the computer, designating which inputs were from the right hand/side and which inputs were from the left hand/side. Optionally, foot sensors can be used to detect movement of the left and right feet to assist in teaching of instruments such as a drum set where the feet may control operation of instruments such as a bass drum and hi-hat.

### CROSS-REFERENCE TO RELATED APPLICATION

This application claims the benefit of priority of U.S. provisional application No. 61/802,594, filed Mar. 16, 2013, the contents of which are herein incorporated by reference.

### BACKGROUND OF THE INVENTION

The present invention relates to percussion equipment and, more particularly, to a percussion electronic device having a mechanism for determining left and right hand actions, such as having separated and marked right and left hand striking areas, having a visual sensor to detect right and left hand motions, and the like.

Learning to play the right and left hand at the correct time and in the correct order is a critical part of learning to be a percussionist. While practice pads allow a player to practice, these items do not provide feedback regarding proper sticking or timing. Moreover, in playing faster percussion rudiments, it can be difficult for the player or for an instructor to verify the correct left and right hand sticking.

As can be seen, there is a need for a device that allows a user to practice percussion while providing feedback about both correct time and correct left and right hand order.

### SUMMARY OF THE INVENTION

In one aspect of the present invention, an electronic percussion device comprises a performance surface to be struck by a percussion player's sticks; a detector to determine which of a right hand/stick or a left hand/stick strikes the performance surface at which time; and a computing device receiving data from the detector to provide feedback to the percussion player.

These and other features, aspects and advantages of the present invention will become better understood with reference to the following drawings, description and claims.

### BRIEF DESCRIPTION OF THE DRAWINGS

FIG. 1 is a schematic perspective view illustrating various elements of an electronic percussion device according to an exemplary embodiment of the present invention;

FIG. 2 is a perspective view illustrating a player using another iteration of the invention; and

FIG. 3 is a perspective view illustrating a player using another iteration of the invention, including foot sensing capabilities.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a percussion electronic device that allows a percussionist to learn, through electronic feedback, the correct playing of the right or left hand with unique or existing computer software. In some embodiments, the percussion device could be a drum pad that is struck by sticks on the right or left side of the pad. In some embodiments, the percussion device can connect to a visual detector, such as a video camera, a smart phone camera, or the like, to detect motions of the user's left and right hands. The computer software may display written music or instructions of what hand to play at what time and the percussion device would input the performance of the percussionist into the computer, designating which inputs were from the right hand/side and which inputs were from the left hand/side. Optionally, embodiments can include foot sensors, detecting movement of the left and right feet. This option may be useful in teaching a drum set, for example, where the feet may control operation of a bass drum and hi-hat.

Referring now to FIG. 1, a drum pad 10 can be made from various materials, such as a hard surface material layer 20 that supports a bouncy material layer 22 disposed thereupon. Typically the hard surface material layer 20 and the bouncy material layer 22 can be shaped round with a diameter from about 6 to about 14 inches, as shown in the Figure, or may be made in other geometric or non-geometric shapes. The layers of the drum pad 10 might be combined if separation of these layers is found to be unnecessary.

The hard surface material layer 20 can be, for example, wood, hard plastic, composite, metal, or the like, having a thickness from about 0.5 to about 2 inches, typically about 1 inch thick. The bottom of the hard surface material layer 20 can include a mechanism, such as one or more female threaded holes, for interconnection the drum pad 10 to a stand (not shown). In some embodiments, the bottom of the hard surface material layer 20 can include pads, such as rubber feet, for supporting the drum pad 10 on a surface.

The bouncy material layer 22 can be formed from various materials and can provide a feel similar to that of striking a well-tuned drum head or percussion instrument. In some embodiments, the bouncy material layer 22 can be a layer of rubber having a thickness from about ⅛ inch to about ½ inch, for example. The top surface of the bouncy material layer 22 can include markings 16, 18 to indicate the right and left sides of the drum pad 10.

Sensors 12, 14 can be disposed on the right side and the left side, independently, to provide a signal when the bouncy surface is struck on that particular side. For example, when the user strikes the left side of the bouncy material layer 22, the left electrical input outputs a signal, and when the user strikes the right side of the bouncy material layer 22, the right electrical input outputs a signal. The number of sensors in the device of the present invention may vary, depending upon application. For example, in some embodiments, the sensors can detect not only which side/hand is being used to play the drum, but also where on the drum the surface is struck, such as near a middle portion of the drum, on the rim of the drum, near the edge of the drum, and the like. The sensors can therefore detect playing elements such as rimshots. The sensors can also detect not only alternating left and right hand playing, but also can detect when the drum pad 10 is struck simultaneously by both the left and right hand playing. This can be useful in detecting proper sticking for drumming rudiments such as flams, flam-taps and the like.

The drum pad 10 can connect to other devices, such as a computer with a display 44, through various signal transmission means, including USB, Bluetooth, Wi-Fi, or the like. A wireless signal port 34 can be provided to send and receive a wireless signal to and from the drum pad 10. An optional button 36 may be pressed to make this connection or indicate the connection with a flashing light or other indicator. In some embodiments, the computer/display 44 can be made integral with the drum pad 10, as shown in FIG. 1.

An optional display 42 can be positioned, for example, on the surface of the drum pad 10 or separated from the drum pad 10 (as shown in FIG. 1) to show the status of the percussion pad, connectivity status, user's performance, music to be performed, and the like. The display 42 can take various forms as may be known in the art. In some embodiments, the display 42 can be a computer device or smartphone display, for example. The display 42 can provide digital feedback on the user's performance and may be used when a computer is not connected to the drum pad.

A power supply port 30 can provide an input for power to be delivered to the drum pad 10. The power supply port 30 can receive an adaptor for plugging in the device, a USB connection, or the like. In some embodiments, the drum pad 10 can be powered by batteries stored in a battery compartment (not shown).

An audio output 32, such as a headphone/line output, can be provided so that users can listen to sounds of their playing or to other music while they play. The output sound from the drum pad 10 can vary depending on various conditions, such as the pressure applied to the drum, the location that the drum pad 10 is struck, the tool used (such as a drum stick, a mallet, brushes, a hand, or the like) to strike the drum pad 10, and the like. The drum pad 10 can include various songs in memory for the user to play along with, or can be programmed with other songs as desired, through for example, the signal transmission means from a computer or other such device.

Pressure sensors could be disposed, independently, on the left and right sides of the drum pad 10. In some embodiments, pressure sensors can also be disposed on optional foot sensors 26, 28 disposed for one or both feet. The foot sensors 26, 28 can connect, for example, to the drum pad 10 through a right and left foot input 24. In some embodiments, the right and left foot sensors 26, 28 can connect to a computing device to which the percussion pad connects via various signal transmission means, such as by a cable, Bluetooth, Wi-Fi, or the like. The foot sensors 26, 28 can be used much like the hands in the present invention to detect the right and left foot performance of the user. The foot sensors could be used with a provided or user-provided pedal or input device for the foot.

The pressure sensors could measure how hard the pad (or foot sensors) are struck and this data can be interpreted by software to make the sound of the drum louder and softer. This data can also be used to provide feedback on the performer as to whether their dynamic performance was correct with the music being performed.

Referring now to FIGS. 2 and 3, a user 52 can be provided with a performance surface 50, which can be a surface provided with embodiments of the present invention or can be a user-provided surface, for example, for striking with drum sticks 46, for example. The performance surface 50 can be various surfaces, such as the drum pad 10 or even a regular drum, such as a snare drum, a tom-tom, a hi-hat, a suspended cymbal or the like. A sensor can be disposed adjacent to the performance surface 50. The sensor can be any type of sensor such as visual or audio sensors and can be used to detect motions of or sounds produced by the user's left and right hands and/or feet to provide an input (much like the pressure sensors described above) as to which stick (or other drumming tool, such as a mallet, brush, or even one's own hand) or foot is used at what time. Sensors may be provided or be user-provided through various forms as may be known in the art. In some embodiments, the sensor can be provided through a computer device 48 or smartphone, for example. This data can be interpreted by software and can be used to provide feedback on the performer as to whether their performance was correct with the music being performed. The sensors may detect not only actions on one drum, but multiple drums such as may be the case with tom-toms, bongos, and the like.

In some embodiments, the computing device 48 may be used to record the performance on the percussion electronic input device whether it be the audio, video, or both. This input can be used electronically with music software, or even for the creation of notated music of the performance.

By using the percussion electronic input device of the present invention, a player can get immediate and useful feedback on both timing, stick order, and, optionally, strike pressure.

It should be understood, of course, that the foregoing relates to exemplary embodiments of the invention and that modifications may be made without departing from the spirit and scope of the invention as set forth in the following claims.

What is claimed is:

1. An electronic percussion device comprising:
a performance surface to be struck by a percussion player;
a detector to determine which of a right hand or a left hand creates a contact with the performance surface at which time; and
a computing device receiving data from the detector to provide feedback to the percussion player.

2. The percussion electronic device of claim 1, wherein the performance surface is a drum pad designed to be struck by the percussion player.

3. The percussion electronic device of claim 1, wherein the performance surface is a percussion instrument.

4. The percussion electronic device of claim 2, wherein markings on the pad designate left and right sides of the pad.

5. The percussion electronic device of claim 2, wherein independent inputs on a left and right side detect when the drum pad is struck on the left or right sides to generating a signal describing the inputs.

6. The percussion electronic device of claim 1, wherein the detector is a sensor configured to sense motion of the right hand and the left hand.

7. The percussion electronic device of claim 1, further comprising a second detector to determine which of a right foot or a left foot makes a predetermined motion.

8. The percussion electronic device of claim 7, wherein the second detector is a left side and right side pressure sensor to detect pressure applied thereto by the left foot and the right foot.

9. The percussion electronic device of claim 8, wherein the performance surface is a drum pad designed to be struck by the percussion player's sticks and the left side and right side pressure sensors connect to a foot sensor port of the drum pad.

10. The percussion electronic device of claim 1, further comprising an external computing device for achieving at least one of receiving a signal from the performance surface, analyzing a performance of the percussion player, and displaying notes to be played by the percussion player.
